(19) United States
(12) Patent Application Publication
(10) Pub. No.: US 2017/0289596 A1
(43) Pub. Date: Oct. 5, 2017

(54) NETWORKED PUBLIC MULTI-SCREEN CONTENT DELIVERY

(71) Applicant: Microsoft Technology Licensing, LLC, Redmond, WA (US)

(72) Inventors: Georgios Krasadakis, Dublin (IE); David Mowatt, Dublin (IE); André Filipe da Silva Correia, Dublin (IE)

(21) Appl. No.: 15/087,832

(22) Filed: Mar. 31, 2016

(51) Int. Cl. H04N 21/258; H04N 21/262; H04N 21/45; H04L 29/08; H04N 21/4223

(52) U.S. Cl. CPC H04N 21/25883; H04L 67/306; H04N 21/4223; H04N 21/4532; H04N 21/262

(57) ABSTRACT

Interactive, multimedia content is presented on multiple display devices in public areas. The display device includes components for recognizing users in viewing areas and selecting content to present the recognized users. Content may be specifically tailored for the recognized users, and the content may be split up into mini-episodes that are displayed across disparate public display devices. As the users are detected at the different display devices, the mini-episodes of content may be presented in a sequential manner, such that a first mini-episode is played at on a first display device, a second mini-episode is play on a second display device, and so on until the content is entirely played. User interactions to the presented content may also be captured and used in future content selections.

### BACKGROUND

The Information Age has quickly pushed today's media content from older print and television mediums onto computing devices. Nowadays, computer screens can be found in public areas replacing billboards and other types of print media. These computer screens present various content to people as they pass by, but the content itself is not specific to the passers-by themselves. The content of public displays is conventionally pre-programmed for display based on content-provider predictions of the types of users that will be in a given public space at future times. This largely makes delivering content that is relevant to users somewhat elusive, because content delivery is not based upon the actual people in an area. Instead, it is determined by a content provider's predictions.

### SUMMARY

The disclosed examples are described in detail below with reference to the accompanying drawing figures listed below. The following summary is provided to illustrate some examples disclosed herein, and is not meant to necessarily limit all examples to any particular configuration or sequence of operations.

Some examples are directed to controlling the display of content on a public display device based on recognized users in an area. In some examples, user-specific data is received comprising one or more physical characteristics of a user in a viewing area of the public display device. Additionally, a location of the public display device and a timeframe for when the at least one user is in the area is identified in various examples. A user profile of the user is accessed or created, and content is selected for presentation to the user based on the location of the public display, the time when the user is in the area, and the user profile.

### BRIEF DESCRIPTION OF THE DRAWINGS

The disclosed examples are described in detail below with reference to the accompanying drawing figures listed below:

FIG. 1 is an exemplary block diagram illustrating a computing device for identifying users in a public area and presenting targeted content.

FIG. 2 is an exemplary block diagram illustrating a networking environment for recognizing users in a public area and distributing content to the multiple display devices.

FIGS. 3A-3B illustrate diagrams of a person being presented with content on separate display devices at different locations in a public area.

FIG. 3C illustrates a diagram of multiple billboard screens being used to present mini-episodes of content.

FIG. 4 is an exemplary diagram depicting multiple displays outputting content to a group of users.

FIG. 5 is an exemplary flow chart illustrating operations of a computing device to display portions of micro-content to a user on a series of displays.

FIG. 6 is an exemplary flow chart illustrating operations of a computing device to identify one or more users.

FIG. 7 is an exemplary flow chart illustrating operations of a computing device to update displayed content.

Corresponding reference characters indicate corresponding parts throughout the drawings.

### DETAILED DESCRIPTION

The examples disclosed herein generally relate to controlling the placement of content on multiple public viewing screens in public spaces, such as in an airport, grocery store, public building, or other arena where multiple displays can be placed. In some examples, the displays are controlled by computing devices with cameras for capturing images or videos of people within the viewing areas of the displays. The captured images or video may be interpreted by recognition software to personally identify the users—or at least recognize various features about them. Content is selected for display on the public viewing screens based on the users currently within the viewing areas. For example, a screen in an airport may be equipped with a camera that captures facial images of users walking by. These facial images may be transmitted to a backend server that may select particular content—e.g., news stories—to present on the display based on the identified users.

Some examples are directed to controlling the display of content on a public display device based on recognized users in an area. In some examples, user-specific data is received comprising one or more physical characteristics of at least one user in a viewing area of the public display device. Additionally, a location of the public display device and a timeframe or actual time when the at least one user is in the area is identified in various examples. Some examples also access a user profile of the at least one user. Further still, some examples provide for selecting the content for presentation to the at least one user based on the location of the public display, the timeframe when the at least one user is in the area, and the user profile of the at least one user. Moreover, some examples also direct presentation of the selected content during the timeframe.

Another aspect of the examples disclosed herein relates to tracking people as they move through public areas and coordinating the content being displayed on multiple public screens based on the movement of the people and the messages that have been previously presented to the people on the public screens. For example, if a building has three screens located in three different hallways, a user walking through the building past the three screens may be presented with a first portion of content when walking by the first screen, a second portion of content when walking by a second screen, and a third portion of content when walking by the third screen. The second, third, and subsequent portions of the mini-episodes, in some examples, depend on the previous mini-episode(s) being presented to the people to create a cohesive media-content experience that builds on the content presented across multiple public screens. Coordinating the content being presented to users across multiple screens allows the disclosed examples to extend the multimedia experience for users beyond the standard few seconds it normally takes to pass by a public screen.

The multiple pieces of content being displayed across different screens may be coordinated as “mini-episodes” of content that are related to each other. As used herein, a mini-episode refers to media content that is related, either by subject of experience, to previously presented content that has been displayed to a user. For example, when a user who is known—through stored user profiles—to be a dog lover is recognized at one public screen, a first mini-episode of content may be presented showing upcoming dog documentaries on cable television in the user's hometown on a first public screen. A second mini-episode about the dogs profiled in one of the dog documentaries may be presented when the user is recognized in front of a second public screen. And a third mini-episode showing a link to a web page about the documentaries and a quick response code (QR code) for additional information covered in the documentaries may be presented when the user is recognized in front of a third public screen. Altogether, the three different mini-episodes represent a collective piece of content that is broken down into different segments and presented to the user as he/she passes by the various screens. In general, the disclosed mini-episodes present multiple pieces of content that are interrelated by subject and either varied or contiguously presented to make up a larger piece of media content, thereby telling a story.

In some examples, the mini-episodes present multiple pieces of content—as variations, alternatives, or subsequent contiguous content pieces—that area associated with a content episode, theme, or other story, thereby telling either a continuous story across multiple device screens or the same story in multiple different ways. For instance, when mini-episodes are presented about a car that an identified user may be interested in, the examples disclosed herein may display three content pieces: one showing the exterior of the car, one showing the interior of the car, and showing an offer or price related to the car. These three episodes may be presented on three public display screens the user passes.

Additionally, the mini-episodes may have multiple variations for each one of the three parts (i.e., exterior, interior, offer), and each variation may have different wording, style, text, logos, graphics, video, audio, animations, or other communication messages (collectively “message components” or “communication message components”) that may be statically set by a web service or dynamically changing depending on things like the user's or other similarly profiled users' responses to the various communication messages components. On a larger scale, the dynamic variation of mini-episode message components and analysis of user feedback to those components enables the various examples disclosed herein to experiment and automatically identify the top-performing message components for the different mini-episodes. For example, in a second mini-episode showing the car's interior, various narrative voices may be played while the interior is shown, and user reactions may be captured and assessed to determine which of the voices elicits the most positive reactions (e.g., highest number of people interact with the content) from passing users. In this manner, some of the disclosed examples use content variations to self-optimize in terms of engagement and start serving optimized content messages to the public.

Some examples are directed to executable instructions for controlling presentation of content with multiple presentable portions on public display devices. The display devices are equipped with cameras or other sensors that identify people within a first public viewing area (e.g., a particular portion of an airport) of a first public display device at an initial time. A person may be “personally” recognized, meaning the person is individually identified, through facial recognition, body recognition, device communication (e.g., wireless communication with the user's smart phone or wearable device), speech recognition, user profile identifier, social media handle, user name, speech, biometrics (e.g., eye pattern, fingerprints, etc.), or any other technique for personally identifying the user. For example, a camera coupled to a display device may capture video of a person, and that video may be analyzed—either locally or via a web service—to recognize the person.

Alternatively or additionally, the user may be “partially” recognized, meaning one or more characteristics of the user are identified but the person himself or herself is not identified, by any of the disclosed recognition techniques mentioned herein. For example, video of the user may be captured that identifies the person the gender, race, height, and build of a user that can be used to select content to present while the person is in the viewing area of the display device.

Additionally or alternatively, some examples “anonymously” track users. In such examples, the display devices may track an anonymized unique identifier that is broadcast by a user's mobile device (e.g., smart phone, tablet, wearable, etc.) or other electronic device that is installed or exposed by the mobile device operating system (OS) or some other software application. Once the unique identifier is obtained, anonymous tracking may be used to associate user actions with the unique identifier, and subsequent mini-episode selection and content presentation may be triggered by recognition of the unique identifier and history of user interactions. For example, an anonymous user may see something of interest on a screen and uses his/her mobile device to scan a QR code, or select an option to “show me more as a I go” on the display. A unique identifier for the user that is initially captured from the user's smart phone, tablet, or wearable, may be associated with the user's viewing of display content, scanning of the QR code, or selection of the “show me more as I go” option, and this association may be used in subsequent content selection. This enables the disclosed examples to track anonymously the user's movement and exposure on the various screens without having to know anything about the specific user except the unique identifier generated as the result of the interaction. For purposes of this disclosure, a user who is identified by a unique identifier may be deemed to be “anonymously tracked,” which may be substituted for any of the references herein for personal or partial tracking.

As mentioned herein, the term “viewing area” refers to a public area in which a person may view content on a public display. In some examples, the viewing area includes a 180° viewing angle of a display device. Other displays, such as a see-through light emitting diode (LED) display, may present content at multiple angles, on front and back panels of a single display device, or on curved displays that extend beyond 180° viewing angles. Examples disclosed herein include equipment capable of recognizing when people are within a given viewing area, and reactively selecting and presenting content for the recognized people to either view or engage.

Along these lines, in some examples, a first mini-episode of content is presented to a user on a first display device at which the user is recognized—personally, partially, or anonymously under an identifier being tracked—during an initial time when the user is present in the viewing area of the first display device. Later, the user may be identified at a second public viewing area of a second display device at which a second mini-episode of content related to, or dependent on, the first mini-episode is presented to the user. For example, a user walking by a first display may be recognized as a middle-aged woman and presented with a first half of a story about breaking news for a particular political candidate who is very popular with middle-aged women. Then, when the user walks by and is recognized (e.g., personally, partially, or anonymously) at a second display in a completely different part of the airport, the second display recognizes the user and, upon recognition, is directed by a web service to play a second half of the breaking-news story about the particular political candidate. In effect, the user gets to view the two mini-episodes for the breaking news story about the politician on the two display devices, thereby extending the user experience beyond the mere seconds it takes for the user to pass by a single display device. This provides an avenue for more robust content to be passed on to users in a given area, targeting them either personally or partially and providing content that is better consumed.

Some of the examples disclosed herein reference a QR code being presented on the display devices 100. Other types of codes may be used as well. Examples include, without limitation, two- and three-dimensional matrix codes, bar codes, infrared codes, picture code, or other indicia that may trigger a client device to perform certain actions (e.g., launch an application or navigate to a web page) upon capture. Any such alternatives to QR codes may be used and are fully contemplated by the examples disclosed herein.

In some examples, the media content discussed herein is presented to users on billboards that the users pass by in a car, bus, train, or other vehicle. In these examples, the various techniques and components disclosed herein recognize the users in the passing-by vehicles—for instance, through facial recognition, license plate identification, personal device (e.g., smart phone) identifiers, or the like—and display content on the billboards that is tailored to the recognized users. Mini-episodes with content that is interrelated may be displayed to a particular user across multiple billboards. For example, when a user driving a convertible is recognized passing by a first billboard, the first billboard may display an advertisement about a particular sporting event the user has historically be interested in (e.g., the Seattle Seahawks® football game). If the user is detected in the car driving by a second billboard, the second billboard may display current updates on the sporting event of interest. Subsequent billboards may also present mini-episodes of content to continually update the user on the sporting event.

In some examples, the car itself may be connected and tracked along with or independent of the user. The car brand, model, color, class (e.g., sport, family, sedan, luxury, etc.), passenger capacity, or the other characteristic may be identified and tracked in order to assume things about the passenger(s) therein. For example, a specific model and color of sports car may be associated with users who like a particular sports team.

Some examples base decisions for presenting mini-episodes and message components based on user identification and interaction. Additionally or alternatively, examples may select mini-episodes and/or message components based on other inputs, such as, for example but without limitation, the time, date, season, location, social signals, major events in-progress, political affiliations, marketing plans, user buying plans, search histories, and the like.

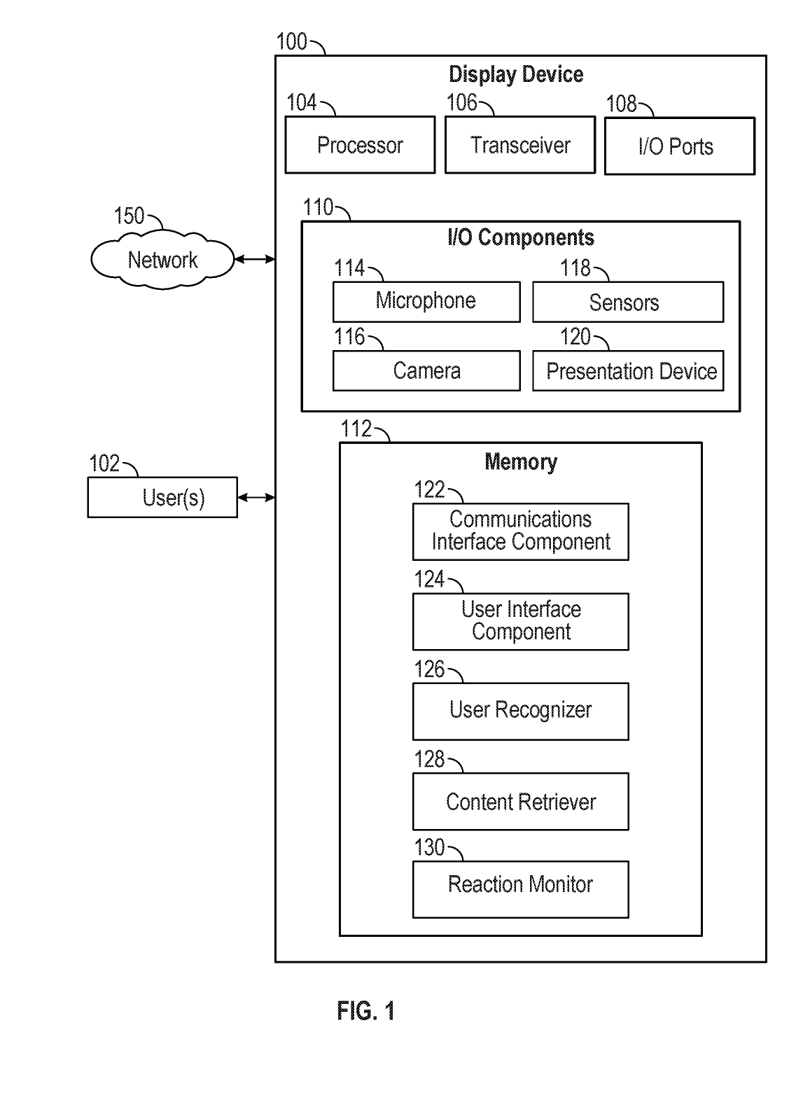

Having generally described at least some of the examples disclosed herein, attention is focused on the accompanying drawings for additional details. Referring to FIG. 1, an exemplary block diagram is provided illustrating a display device 100 configured to monitor users 102 within a viewing area and selectively present content based on the users being personally, partially, or anonymously recognized. The depicted components of the display device in FIG. 1 are provided merely for explanatory purposes and are not meant to limit all examples to any particular device configuration.

The display device 100 represents any device executing instructions (e.g., as application programs, operating system functionality, or both) to implement the operations and functionality described herein associated with the display device 100. In some examples, the display device 100 has at least one processor 104, one or more transceiver 106, one or more input/output (I/O) ports 108, one or more I/O components 110, and computer-storage memory 112. The display device 100 is also configured to communicate over a network 150. More specifically, the I/O components 110 include a microphone 114, a camera 116, sensors 118, and a presentation device 120. The computer-storage memory 112 is embodied with machine-executable instructions comprising a communications interface component 122, a user interface component 124, a user recognizer 126, a content retriever 128, and a reaction monitor 130 that are executable to carry out the various features disclosed below.

The display device 100 may take the form of a mobile computing device or any other portable device, such as, for example but without limitation, computer monitor, an electronic billboard, a projector, a television, a see-through display, a virtual reality (VR) device or projector, a computer, a kiosk, a tabletop device, a wireless charging station, and electric automobile charging stations. Furthermore, the display device 100 may alternatively take the form of an electronic component of a public train, airplane, train, or bus (e.g., a vehicle computer equipped with cameras or other sensors disclosed herein).

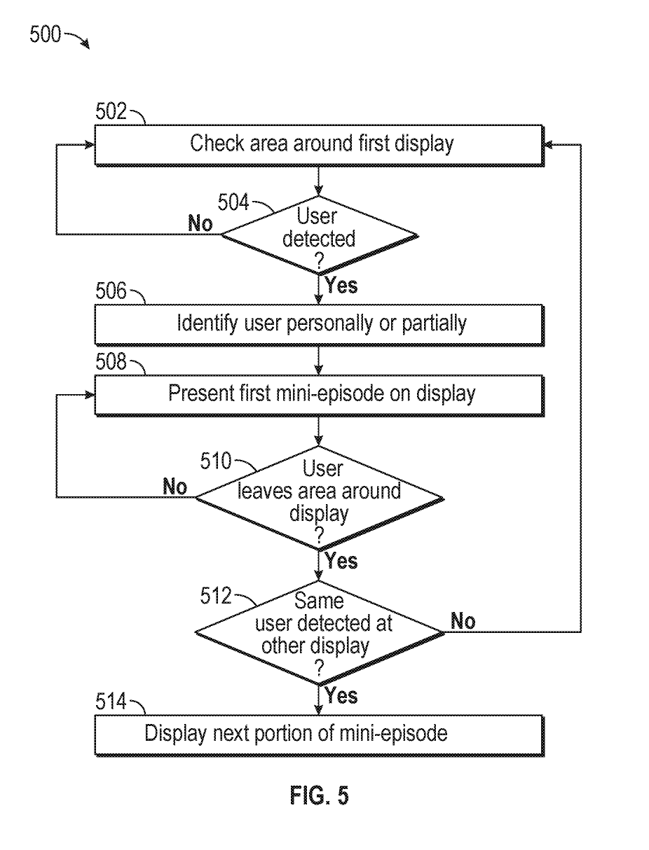

The processor 104 may include any quantity of processing units, and is programmed to execute computer-executable instructions for implementing aspects of the disclosure. In operation, the processor 104 executes instructions for the user recognizer 126, the content retriever 128, and the reaction monitor 130. In some examples, the processor 104 is programmed to execute instructions such as those illustrated in accompanying FIGS. 5-7, thereby turning the display device 100 into a specific-processing device configured to present content and monitor user interactions in the manner disclosed herein.

The transceiver 106 is an antenna capable of transmitting and receiving radio frequency (“RF”) or other wireless signals over the network 106. One skilled in the art will appreciate and understand that various antennae and corresponding chipsets may be used to provide communicative capabilities between the display device 100 and other remote devices. Examples are not limited to RF signaling, however, as various other communication modalities may alternatively be used. The display device 100 may communicate over network 150. Examples of computer networks 106 include, without limitation, a wireless network, landline, cable line, fiber-optic line, local area network (LAN), wide area network (WAN), or the like. The network 150 may also comprise subsystems that transfer data between servers or display devices 100. For example, the network 150 may also include a point-to-point connection, the Internet, an Ethernet, a backplane bus, an electrical bus, a neural network, or other internal system.

I/O ports 108 allow the display device 100 to be logically coupled to other devices and I/O components 110, some of which may be built in to display device 100 while others may be external. Specific to the examples discussed herein, I/O components 110 include a microphone 114, a camera 116, one or more sensors 118, and a presentation device 120. The microphone 114 captures audio from the users 102. The camera 116 captures images or video of the users 102.

The sensors 118 may include any number of sensors for detecting the users 102, environmental conditions in the viewing area, or information from client devices (e.g., smart phone, tablet, laptop, wearable device, etc.) of the users 102. For example, the sensors 118 may include an accelerometer, magnetometer, pressure sensor, photometer, thermometer, global positioning system (“GPS”) chip or circuitry, bar scanner, infrared receiver, BLUETOOTH® branded receiver, NFC receiver, biometric scanner (e.g., fingerprint, palm print, blood, eye, or the like), gyroscope, near-field communication (“NFC”) receiver, or any other sensor configured to capture data from the user 102 or the environment, or any other sensors configured to identify the users 102 or capture environmental data.

The presentation device 120 may include a monitor (organic LED, LED, liquid crystal display (LCD), plasma, see-through, etc.), touch screen, holographic display, projector, digital and/or electronic sign, VR display, and/or any other suitable type of output device. The presentation device 120 may be curved, bendable, see-through, projected, straight, or other configurations of display.

The illustrated I/O components 110 are but one example of I/O components that may be included on the display device 100. Other examples may include additional or alternative I/O components 110, e.g., a sound card, a vibrating device, a mouse, a scanner, a printer, a wireless communication module, or any other component for capturing information related to the users 102 or the environment.

The computer-storage memory 112 includes any quantity of memory associated with or accessible by the display device 100. The memory 112 may be internal to the display device 100 (as shown in FIG. 1), external to the display device 100 (not shown), or both (not shown). Examples of memory 112 in include, without limitation, random access memory (RAM); read only memory (ROM); electronically erasable programmable read only memory (EEPROM); flash memory or other memory technologies; CDROM, digital versatile disks (DVDs) or other optical or holographic media; magnetic cassettes, magnetic tape, magnetic disk storage or other magnetic storage devices; memory wired into an analog computing device; or any other medium for encoding desired information and for access by the display device 100. Memory 112 may also take the form of volatile and/or nonvolatile memory; may be removable, non-removable, or a combination thereof; and may include various hardware devices (e.g., solid-state memory, hard drives, optical-disc drives, etc.). Additionally or alternatively, the memory 112 may be distributed across multiple display devices 100, e.g., in a virtualized environment in which instruction processing is carried out on multiple devices 100. For the purposes of this disclosure, “computer storage media,” “computer-storage memory,” and “memory” do not include carrier waves or propagating signaling.

Instructions stored in memory 120 may include the communications interface component 122, the user interface component 124, the user recognizer 126, the content retriever 128, and the reaction monitor 130. In some examples, the communications interface component 122 includes a network interface card and/or a driver for operating the network interface card. Communication between the display device 100 and other devices, such as servers hosting a web service or client devices of the users 102, may occur using any protocol or mechanism over a wired or wireless connection, or across the network 106. In some examples, the communications interface component 122 is operable with radio frequency (RF) or short-range communication technologies using electronic tags, such as NFC tags, Bluetooth® branded tags, or the like. In some examples, the communications interface component 122 communicates with a remote content store, which may be in a remote device (such as a server) or cloud infrastructure. The remote content store, for example, may receive, store, and send data related to content analytics, user analytics, and/or pattern data relating to the users 102, or similar users.

In some examples, the user interface component 124 includes a graphics card for displaying data to the user and receiving data from the user. The user interface component 124 may also include computer-executable instructions (e.g., a driver) for operating the graphics card to display QR codes related to the content being selectively provided to the users 102. For example, content about a particular automobile may be presented on the presentation device 120 along with a QR code that can be scanned by user 102 smart phones that direct them to a web page with more information about the presented automobile.

Alternatively or additionally, the display device 100 may, in some examples, communicate such additional or supplemental information to the client devices of the users 102 wirelessly through a BLUETOOTH® branded, NFC, infrared, or other type of communication. For example, a user 102 may touch their smart phone to an NFC sensor of the display device 100, causing supplemental information about the displayed content (e.g., registration information, web page, electronic coupon, etc.) to be communicated to the display device 100 and stored in the memory 112.

The user recognizer 126 includes instructions to recognize the user(s) 102, either personally, partially, or anonymously, using the captured image, video, or audio from the camera 116 and microphone 114, or from the sensors 118. The user recognizer 126 may employ facial, speech, motion, biometric, gesture, or other types of recognition software. In some examples, the user recognizer 126 identifies the user from biometric characteristics in the captured image, video, or audio data, such as eye scans, facial recognition, speech or voice recognition, fingerprint scans, or the like.

The user recognizer 126 may alternatively or additionally provide the captured image, video, audio, or sensor data over the network 106 to a web service that may then identify the users 102 through comparison against a database of subscribed users—either personally based on stored characteristics and user profiles or partially based on image, video, audio, or sensor data analysis. For example, partial user recognition may occur by comparing user heights with reference objects that are in the viewing area to understand a user 102's height or size. The builds of the users 102 or their hair lengths may be analyzed to determine whether they are males or female. Clothing insignia may be analyzed to determine preferences and likes: for example, a user 102 with a Seattle Mariners jersey may be identified as a fan of baseball and/or a resident or Seattle, Wash. Myriad other indicators in the image, video, audio, and sensor data may be used to personally or partially identify the users 102, either directly by the display device 100 or by a web service.

The user recognizer 126 may include instructions for broadcasting wireless signals to or receiving wireless signals from client devices in an area. For example, a smart phone of a user 102 may be communicated with wirelessly to capture the phone's MAC address, which may be used to personally identify the user 102. In such scenarios, the user recognizer 126 may push, pull, or just receive information from the client devices.

The content retriever 128 includes instructions for retrieving presentable content for the recognized user 102. Content may include any audio, video, image, web content, actionable insignia, or other data that can be visibly, audibly, or electronically provided to the user 102. Examples of content include, without limitation, QR codes, electronic messages (e.g., text, e-mail, coupons, etc.), interactive hyperlinks, advertisements, news stories, sporting events, stock quotes, documents, and the like. Virtually anything that can be presented in electronic form may be presented across the public display devices 100 disclosed herein upon recognition of the users 102.

In some examples, the reaction monitor 130 monitors the reaction of the user 102 to the content being displayed to determine the level of engagement or interest of the user 102. Positive, indifferent, and negative reactions to the content may be gathered by analyzing, through the camera 116, microphone 114, or sensors 118, how a user 102 that was recognized reacts to the presented content. For example, a user 102 who stops to look at the content may be interpreted as a having reacted in an interested manner; whereas, users 102 that do not stop may be interpreted as disinterested. If the user 102 is interested, additional mini-episodes of the content may be presented to the user 102, either on the current display device 100 or other display devices 100 before which the user 102 is identified.

More sophisticated techniques may also be used, for example in conjunction with the various sensors 118 of the display device 100. For instance, the eyes of the user 102 may be tracked to determine whether he or she is watching the content, or particular portions of the content, being presented. A touch screen device may be monitored to determine whether the user 102 is engaging with the content. Electronic coupons may be monitored for spending to determine whether a coupon campaign successfully engaged the user 102. Gesture-recognition software may be implemented by the reaction monitor 130 to determine the level of engagement of the user 102. Numerous other examples for recognizing and interpreting user interactions may alternatively be used.

Additionally or alternatively, users 102 may be recognized by the user recognizer 126 either individually or as part of a group of people within the viewing area. Because the public devices 100 are located in public areas, it is often the case that numerous users 102 are within the viewing areas at any given time. Examples may select content—either on the display device 100 or by a web service—to present to a group of users based on the user profile of one of the users 102 in the group, a collection of users 102, or all the users 102. For example, if five users 102 are detected in a viewing area but only two of them can be personally identified, then content may be selected for those two personally identifiable users 102, thereby disregarding the other three. Alternatively, if a majority or collection of the detected users 102 have a common trait (e.g., a particular gender, body type, etc.), the content may be selected based on the most commonly possessed trait. For example, if ten women are identified and two men are identified, the content retriever 128 may be configured to present content that is tailored toward women instead of men.

The display device 100 may be configured to operate in various different use scenarios. Some, though not all, of these scenarios are now described. In some examples, the presentation device 120 displays content (e.g., sports results) and also a QR code, uniform resource locator (URL), tiny URL, or the like, with a specific call-to-action that includes instructions for a user to register themselves with a particular service (e.g., sports service) to continue following a particular story, read more information about the displayed content (e.g., news stories) online. Such examples allow the users 102 to scan a displayed QR code on the display device and connect to supplemental information, thereby enhancing the user experience through mobile or client computer applications. A passing-by user 102 who finds the content being displayed interesting may subsequently scan the QR code served in order to explore more information through the connected mobile app or asynchronously through a desktop application (e.g., a web browser plug-in), web browser, or social networks via a tag disclosed after this interaction.

In some examples, a user 102 may claim a public offer (such as a coupon) via the QR code scanning. The public device 100 presents content (e.g., an advertisement) and a special call-to-action regarding a public offer via a QR code. Users 102 may scan the QR code and claim the offer. Also, they may be set up for a certain number of claims, and each QR claim reduces the available stock of workable coupons for a specific timeframe. Such offers and coupons may be specific to a particular location, and certain display devices 100 may present different coupon offers depending on the surrounding commercial ecosystem. For example, coupons on display devices 100 within a mall may be for stores for stores in the mall, coupons at a sporting arena may for concession items at the arena, coupons at a train station may provide offers for restaurants at train destinations, and so on. In other words, the offers may be focused on the location of the display devices 100.

Alternatively or additionally, the offers may be tailored to the user 102 recognized by the user recognizer 126. For instance, a user 102 who has been searching for a particular vehicle through other search engines that feed into user profile databases may be presented with key specific information about the automobile (e.g., available trim packages, horse power, price, miles per gallon, etc.), either as part of the content presented to the user 102 or through an online pathway reached via a QR code, URL, tiny URL, or other type direction. In some examples, users 102 may register interest for content (e.g., particular sport, advertisement, etc.) via QR code scanning.

In other scenarios, the promoted call to action initiated through QR code scanning may be a request for more information about a product, service, device, event, or other portion of the content being displayed to the user 102. In some examples, the user 102 scans the QR code and is automatically registered to receive additional info in one or more preferred communication channels, such as text messaging, e-mail messaging, wearable device alert, etc. Such interaction may also or alternatively be voice driven through a virtual assistant (e.g., the CORTANA® branded assistant provided by the Microsoft Corporation® headquartered in Redmond, Wash.).

In another scenario, the display device 100 may present interactive content, and the user may speak instructions that are interpreted by the user recognizer 126—or some other speech recognition software on the display device 100 (not shown) or a web service—and responded to accordingly. For instance, a user 102 saying “take me there” or “give me directions” may cause the content retriever 128 to generate a QR code that, when scanned, provides a map or other location information (e.g., turn-by-turn directions on a smart watch) to a particular location of interest. The user may then scan the QR code and use the map or location information to find the location of interest. The map or location information may be conveyed to the user on their client device verbally, e.g., through a virtual assistant.

In another scenario, a user 102 may have a smart phone, mobile tablet, or wearable device with an application installed that sends signals wireless (e.g., BLUETOOTH® branded, NFC, etc.) signals that may be captured by the transceiver 106. These wireless client signals may identify the user 102 (e.g., user identifier, social media profile, etc.) of the client device or the device itself (e.g., MAC address) in order to allow the content retriever 128 to better serve the user 102 by presenting content that is likely of interest to the user 102. In this scenario, the display device 100 may also wirelessly communicate responses back to the client device, thereby allowing the client device and display device 100 pair themselves together and exchange information about content, audience analytics (e.g., gender, race, preferences, history, location, etc.), or other types of information.

The display device 100 may capture interaction with passing-by users 102 through multiple channels. For example, smart phones, tablets, or wearable devices of the user 102 may submit signals via a pre-installed application. QR codes may be scanned. The microphone 114, camera 116, and sensors 118 may capture information about the user 102 or the environment.

The reaction monitor 130 may estimate or detect what parts of the screens, as mapped to certain content containers or objects, of the presentation device 120 that one or more users 102 are staring at during any particular point in time. In this sense, the reaction monitor 130 may detect if there are any registered users 102 (i.e., users 102 who have registered with a particular software application), personally identifiable users 102, and/or anonymous users 102. In any of these scenarios the content retriever 128 may communicate with a web service that analyzes patterns along with the history of the specific audience and the sequence of content packages served so far within a given display session. All this information may be combined by a content optimization algorithm which generates the next-best-content package to serve to the specific audience. Given that a group of identified, connected people are looking at the screen, the display device 100, via the web service, already knows what has been served so far to the users 102, their reactions to the previously served content (e.g., time spent viewing/interacting with the content or whether a QR code was scanned), the interests of the users 102, the historical usage or preference patterns of the users 102, or the like. With such user-specific information, the content retriever 128 or the web service may select an optimal mix of content for the specific group, taking into account the aforesaid information.

Using geographic location information or direct communication with the client device of the user 102 (e.g., through BLUETOOTH® branded communications, NFC communications, or the like), the display device 100 may present a sequence of related content to a user 102 across multiple display devices 100 as the user 102 walks through a public airport, shopping mall, super market, square, conference space, or other area. This allows the content to be presented to the user 102 as mini-episodes that are both shorter in length individually but that together form a collective and cohesive story.

For example, suppose that a car brand wants to promote a specific car model through a network of public displays 100 in an airport. A special campaign consisting of multiple, independent but highly related mini-episodes of content are created showcasing a particular car of the brand. As a user 102 enters the viewing area of a first display device 100 in the airport, the user 102 experiences the first mini-episode presenting a specific aspect of the car. The user may look at the screen for X seconds, and the interaction is captured by the reaction monitor 130 for the user 102. As the user 102 moves through the airport, he/she approaches another display device 100 that is part of the same network of display devices 100. The path of the user 102 is known due to the previous interaction (i.e., looking at the screen for X seconds) with the prior display device 100, and it is also known that the first mini-episode has been presented and positively received. As such, another aspect of the car may be presented to the user 102 on the second display device 100. Again, the reaction of the user 102 may be captured, analyzed, and used to queue the next mini-episode to serve the user 102 the next display device 100 the user is identified at. At the same time, the interactions of the user 102 are constantly captured and sent to a web service that stores the interactions in association with the user 102, the content, or both. This type of data collection may serve to better select future content for the user 102 or to judge the overall effectiveness of the content as it is consumed by large audiences of consumers one-by-one.

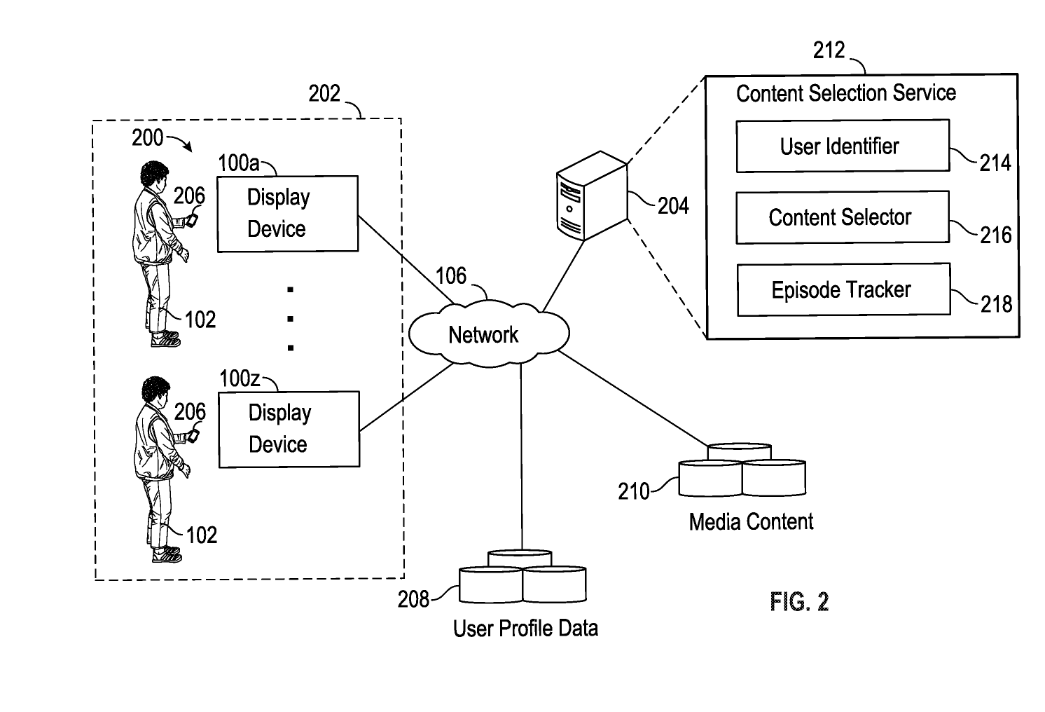

FIG. 2 is an exemplary block diagram illustrating a networking environment 200 for recognizing users 102 in a public area 202 and distributing content to the multiple display devices 100a-z. The display devices 100 communicate over the network 106 with an application server 204 that provides content to be displayed to the user 102 while he/she is in the viewing areas of the display devices 100a-z. Networking environment 200 also involves database cluster 208 storing user profile data about users 102 and database cluster 210 storing content for display on the devices 100a-z. The user profile data and content in database clusters 208 and 210, respectively, may be pushed thereto by other software services, which are outside of the realm of this disclosure. Architecture 200 should not be interpreted as having any dependency or requirement related to any single component or combination of components illustrated therein.

The public area 202 may be an airport, mall, sporting event, public square, commercial building, or any other area where public displays 100a-z may be provided. Public area 202 may include separate physical buildings or locations, such as an airport and a library, a mall and a hotel, or any other areas where large amounts of human traffic is experienced. In other words, the disclosed examples are not limited to a single building or area. The networked display devices 100 may be positioned in different locations and structures. Moreover, only two display devices 100a and 100z are shown for the sake of clarity. As indicated by the ellipses between the two display devices 100a and 100z, any number of networked display devices 100 may be controlled using the various techniques and devices disclosed herein.

The display devices 100a-z communicate with an application server 204 over the private, public, or hybrid network 106, which may include a WAN, MAN, or other network infrastructure. In some examples, the display devices 100a-z are equipped with microphones 114, cameras 116, or sensors 118 that capture identifying information (e.g., images, video, audio, or environmental data) about a user 102 passing by or the user's client device 206. This identifying information may include the name, user identifier (user id), profile, or other personal identification of the user, or MAC address, Internet Protocol (IP) address, or other device identifier of the client device 206, and the identifying information may be transmitted from the client devices 100 to the application server 204.

The application server 204 represents a server or collection of servers configured to execute a content selection service 212 that, in some examples, monitors the location of the user 100—as determined by the display devices 100a-z the user 102 is recognized in front of—and selects content to present the user 102 at the various display devices 100a-z. Specifically, the content selection service 212 on the application server 204 includes memory with executable instructions comprising a user identifier 214, a content selector 216, and an episode tracker 218. The illustrated instructions may or may not all be hosted by the application server 204. Instead, some examples may include any of the depicted instructions of the content selection service 212 on remote devices or as part of other web services.

In operation, the user 102 is detected at display device 100a, and identifying information about the user 102 and/or the client device 206 is transmitted to the application server 204. The user identifier 214 may query database cluster 208 with any or all of the received identifying information about the user 102 or the client device 206 to obtain a user profile and history of content that has been presented to the user. Alternatively or additionally, the user identifier 214 may access an in-memory or accessible cache to retrieve the user profile and history of content that has been presented.

The user profile may include data about the user, such as, for example but without limitation, gender, race, age, residence, citizenship, likes, preferences, hobbies, profession, personal property (e.g., current automobile, golf equipment, watch, etc.), relationship status, online history (e.g., web pages visited, articles read, movies watched, etc.), or the like. The use profile may also include past episodes, mini-episodes, or other content that has presented to the user on the display devices 100, the client device 206, or any other networked computing device. Along with the consumed content previously presented to the user 102, the user 102's interactions with such content may also be stored in association with the user profile data. Cumulatively, the user profile data may store who the user 102 is, what he or she has consumed, and whether the user 102 interacted with the presented content in any meaningful way. Meaningfulness of interactions may be determined by identifying and assessing the interactions based on predefined interaction ratings. For example, a user stopping to view content may be ranked above a user walking by while content is played but ranked lower than a user who engages a touch screen of the display device 100. Various rating schemes exist and may be employed in different ways.

Alternatively, the identifying information received at the application server 204 may only partially identify the user 102. In such examples, the user identifier 214 may query the database cluster 208 to ascertain information for similarly profiled individuals. The content consumption and interactions of users may be stored as user profile data in a manner that can be filtered by one or more identifiable attributes. For example, if the user 102 is identified as a man wearing a particular sports jersey and having a specific clothing style, the user profile data may be queried for successful (e.g., more likely engaged than not) content episodes that have been presented to other users with the same characteristics.

The content selector 216 selects media content from database 210 that is likely to be engaged based on the user profile data of the user 102 or the history of other user interactions with characteristics in common with the user 102. Additionally or alternatively, the media content in the database 210 may be tagged or otherwise associated with particular user characteristics (e.g., age, residency, gender, etc.) by media-content creators in order to focus messages being sent to the users 102. For example, an update on a particular sporting team may be created and designated for dissemination to a particular registered fan base, and that fan-base association may be indicated in the user profile data (e.g., through association with a particular team's social media content). The team media content may then be presented exclusively to users 102 who are registered fans of the sporting team.

In another example, users 102 may be targeted for media content based on their web search histories. For instance, a user searching for the latest specifications of a particular sports car may be presented with video content and reviews about the sports car—in one or more episodes—on the display devices 100a-z. Numerous other examples exist for tailoring media content to users based on identifiers specific to the user or the user's history.

In some examples, the episode tracker 218 monitors the mini-episodes the user 102 has been exposed to on the display devices 100a-z. For example, an entire episode of content may be broken down into three mini-episodes. Mini-episode 1 may show a sports car driving. Mini-episode 2 may show reviews and testimonials of the sports car. Mini-episode 3 may show dealers in a given city of the sports car. In some examples, the episode tracker 218 identifies when the first mini-episode has been presented to user 102 on a first display device 100a. The content selector 216 may elect to present the second mini-episode on a second display device 100b in which the user is detected. And the third mini-episode may be presented on the third display device 100c upon user detect.

Content may be dynamic in the sense that content presented therein may be updated in real time. For instance, a news feed may be presented to the user 100 on separate display devices 100a-z, and the presented news feed may include a portion for current news that is kept up to date in real time. Similar real-time information may also be conveyed through QR code generation. In some examples, QR codes are generated in real time to provide supplemental information that is up to date.

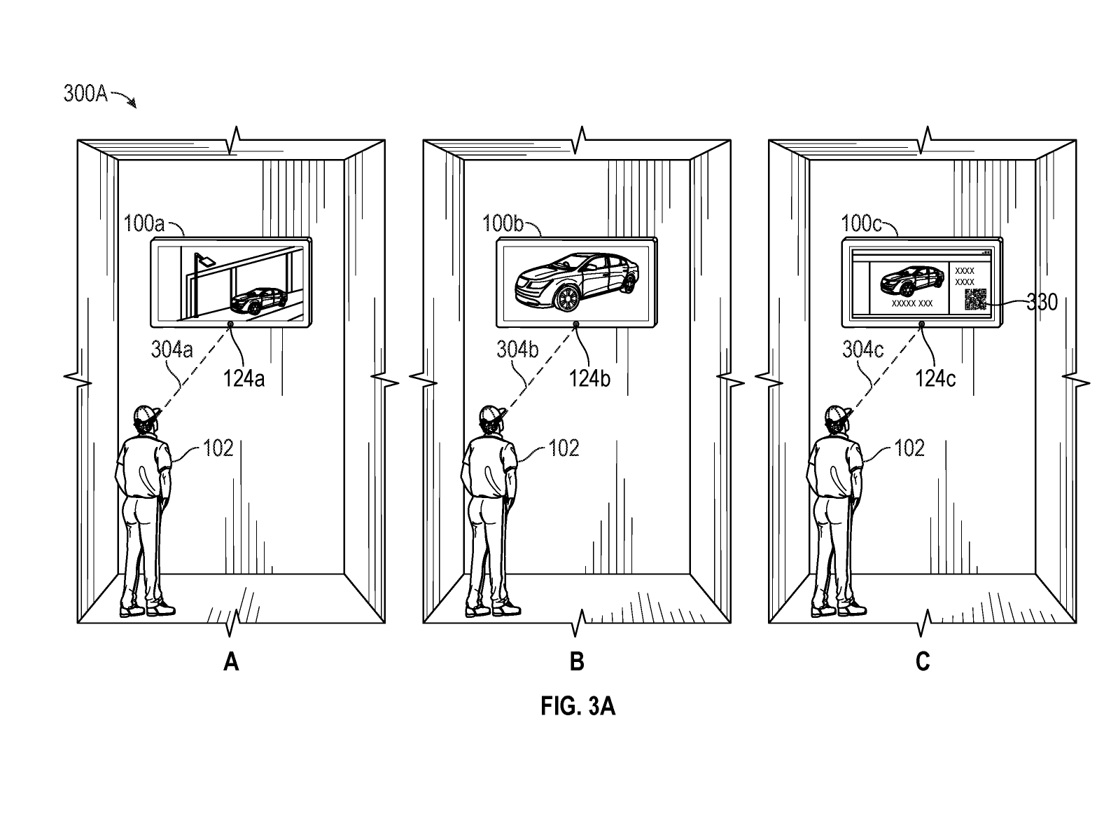

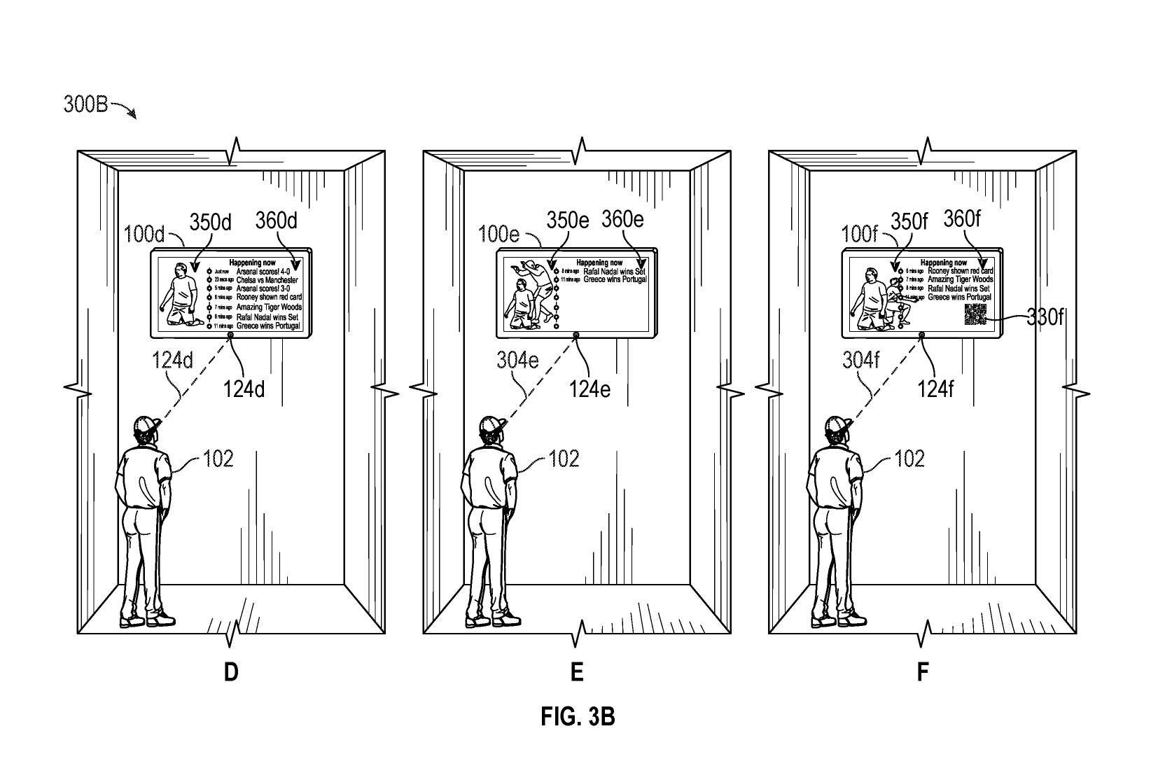

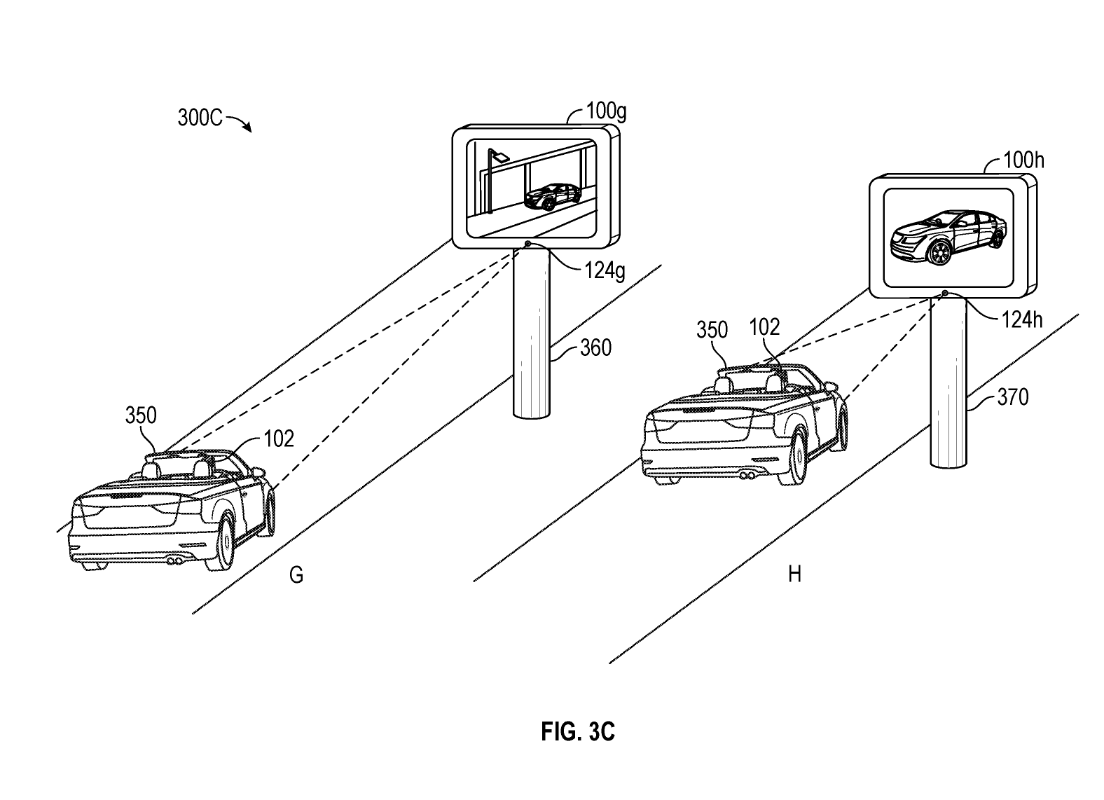

FIG. 3A illustrates a diagram 300A of a person 102 being presented with content on separate display devices 100a-c at different locations A-C in a public area. Locations A-C may be different hallways, rooms, or public areas or the same area at a different time in which display devices 100a-c are viewable. The display devices 100a-c detect when the user 102 is within a particular lines of sight 340a-c by cameras 124a-c, respectively, and the display devices 100a-c retrieve media content, either locally or from the content selection service 212, to display to the user 102. As shown, for example, when the user is at location A, a mini-episode showing a sports car that the user was previously searching online for is shown in a video driving down a street. At location B, the user 100 is shown another mini-episode about the car; one that shows closer-up images of the car's exterior. At location C, the user 102 may be provided with technical details about the car along with a QR code 330 that the user 102 may scan to access additional supplemental information. Collectively, the three mini-episodes make up a larger episode of content in which the user 102 is presented quite a bit of information about the car.

FIG. 3B illustrates a diagram 300B of the person 102 being presented with content on separate display devices 100d-f at different locations D-F in a public area. Locations D-F may be different hallways, rooms, or public areas in which display devices 100d-f are viewable. The display devices 100d-f detect when the user 102 is within a particular lines of sight 340d-f of cameras 124d-f, respectively. The display devices 100d-f retrieve media content, either locally or from the content selection service 212, to display to the user 102.

In this shown example, the user is determined to be a fan of a particular soccer team. When the user is at location D, a first mini-episode showing a live sports event 350d in real time and a dynamically updating play-by-play list 360d of the events of the game is show is presented. At location E, a second mini-episode is shown that contains the live event 350e at a second time and the most recent play-by-play list 360e. At location F, a third mini-episode is shown that contains the live event 350f at a third time along with the most recent play-by-play list 360f and a QR code 330f for more information about the game or the teams playing. These three mini-episodes present content that likely is of interest to the user 102 in a manner that updates across multiple display devices 100d-f. When the cameras 124d-f detect other users 102 with different interests, the content being displayed is changed according to the user preferences and history of the other users 102.

FIG. 3C illustrates a diagram of multiple billboard screens 100g and 100h that a user 102 in a car passes at different times G and H. To clarify, the user is driving along a road and passes billboard screen 100g at time G, and then later passes billboard screen 100h at time H. Cameras 124g and 124h recognize the user 102 approaching the various billboard screens 124g and 124h. The user 102 may be recognized in other ways, such as by license plate number; partially by car color, make, or model; anonymously by unique client device identifier form a device of the user 120 or the car; or in any other way disclosed herein. As the user 102 approaches billboard screen 100g at time G, a first mini-episode of content is displayed. Later (e.g., seconds, minutes, days, etc.), when the user 102 approaches the second billboard 100h, a second mini-episode of content that is related to the first mini-episode is presented to the user 102. In this manner, content may be sequentially presented to the user 102 based upon billboard screens.

Public areas are invariably crowded with multiple people. The attractiveness of certain areas as places for public displays 100 is often the fact that such areas experience quite a bit of foot traffic. So it is often the case that the disclosed display devices 100 must decide which user or users 102 in a viewing area should dictate the content being displayed. For instance, if twenty people are in a particular viewing area, displaying a mini-episode directed toward one user 102 may not be the most efficient use of the display device 100. Or, in another example, if a merchant only wishes to offer ten electronic coupons, presenting a QR code for downloading the coupon to a group of fifty people may not work. Therefore, some examples take into account the group of people in a viewing area when selecting content to be displayed. Personal or partial identification of the users in the group and similar user characteristics among the group may be used to select content. For example, if a group is largely made up of women above the age of thirty, content that has been successfully engaged by such a group may be presented, even though several men or women under the age of thirty are also in the viewing area.

User profiles of the users 100 in the viewing area who are personally identified may be updated to reflect that they have been shown the media content, and interactions (e.g., stopping/not stopping, watching/not watching, scanning QR code, etc.) of the users 102 may be recorded as well. Such examples provide a way to present content to masses of people and individually record their reactions thereto. These reactions and presented content may later be used to select other content to present the individual users 102 when they are in viewing range of other display devices 100. For example, recognized women in the aforesaid group of over-thirty-year-old women who positively engaged with the presented content may be shown subsequent mini-episodes for the content; whereas, women who did not engage may be shown other content.

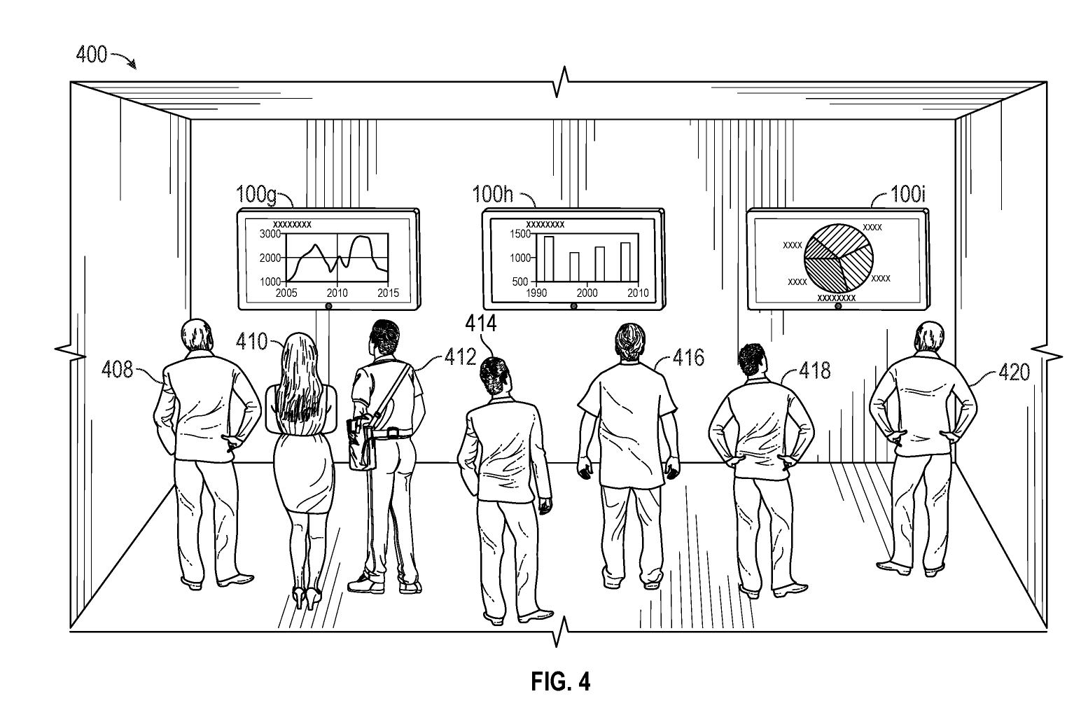

FIG. 4 illustrates a block diagram 400 depicting multiple displays 100g-i in a single public area outputting content to a group of users 408-420. The depicted example shows that multiple display devices 100 may occupy a particular space, such as a large room or an airport terminal, and users may congregate around the display devices 100 presenting information they deem interesting. The display devices 100g-i present content that is tailored for the group of people within their respective viewing areas, while also, in some examples, monitoring user interactions with the displayed content.

The shown display devices 100g-i are presenting different types of data that is relevant to attendees of a conference. Specifically, display device 100g presents particular information the content selector 216 has selected for users 408-412. Display device 100h presents information the content selector 216 has selected for users 414-416. Display device 100i presents information the content selector 216 has selected for users 418-420.

If the users move from the viewing area of one display device (e.g., 100h) to the viewing area of another display device (e.g., 100g), the two display devices may notice that the user has moved, report the movement to the content selection service, and adjust the content being presented on the display devices based on the moving user. For example, if user 414 moves into the viewing area of display device 100g, the content presented on display device 100g may be tailored to the new group before it consisting of users 408-412 while the content on the display device 100h may be focused solely on user 416.

Additionally or alternatively, content presented on the display devices may be tailored to specific audience members in the room, and then subsequently presented content may be tailored to others in the room. For instance, users 408, 410, and 412 may be detected in front of display device 100g. Display device 100g may then present content tailored to users 408 and 412 first, and then present content tailored to user 410. Selection of which content to present first may be determined by the content selection service 212 based number of users in the group (e.g., server the largest group first), largest number of personally recognized users, largest group of users, most interactive group, most likely interaction response (e.g., based on cumulative user interaction histories), or the like. Such examples optimize the content experiences by sequentially serving a first portion of content on a screen that is tailored to a subset of the audience in front of the screen, and then a second portion of content that is tailored to a second subset of the audience in front of the screen, and so on.

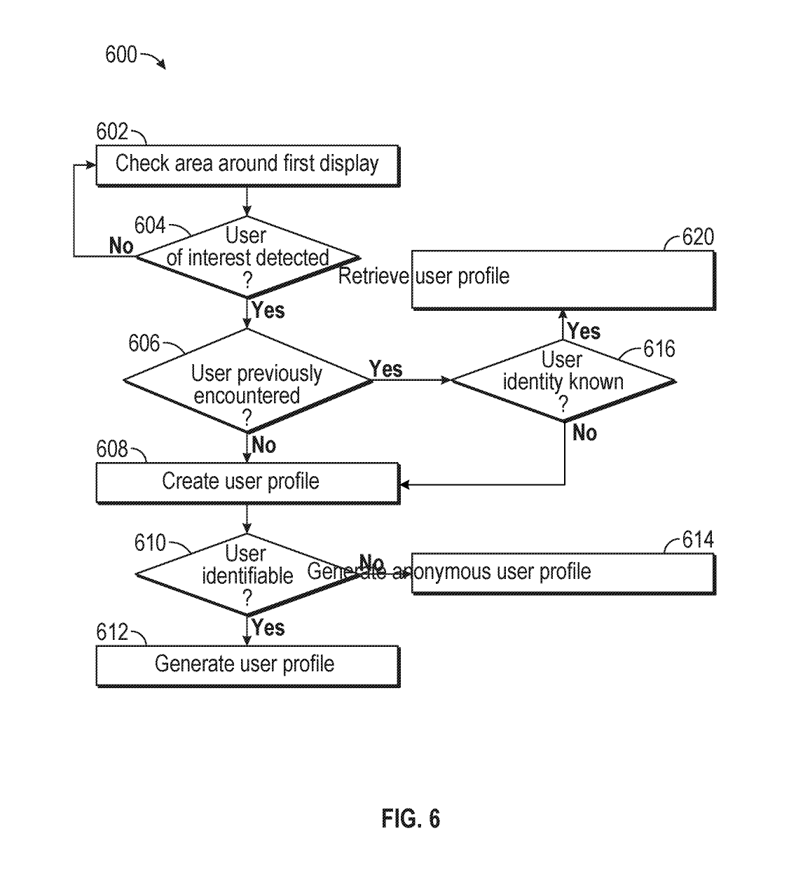

FIG. 5 is a flow chart diagram that illustrates a work flow 500 for displaying content to a user on a series of displays. Initially, at a first display device 100, the viewing area is checked to determine whether any users are present, as shown at 502 and decision box 504. The viewing area is routinely monitored until a user is detected, as shown by the No and Yes paths from decision box 504. When a user is detected, the user recognizer 126 of the first display device 100 attempts to recognize the detected user, either personally or partially, as shown at 506. Such detection may be carried out using the work flow 600 disclosed in FIG. 6.

Once the user is identified, the content retriever 128 of the display device 100 retrieves a first mini-episode to present the user, as shown at 508. The user is monitored by the reaction monitor 130 to determine his or her reaction to the mini-episode and to determine whether the user leaves the viewing area, as shown by decision box 510. If the user stays, a positive interaction is interpreted and stored by the content selection service 212, and the first mini-episode is allowed to continue playing, as shown by the No path from decision box 510. If the user leaves, however, the mini-episode may be halted or continued, in different examples. As shown at decision box 512, if the user is detected at another display device 100, the next mini-episode of content related to the first may be displayed on the other display device, at shown at 514. As shown by the No path from decision box 512, work flow 500 repeats if the user is not found at detected before another display device 100.

FIG. 6 is a flow chart diagram that illustrates a work flow 600 for identifying one or more users. As shown at 602, a viewing area around a display is checked for users. As shown by decision box 604, the viewing area is routinely or continually monitored until a user is detected. When the user is detected, the user identifier 214 attempts to identify the user personally or partially and decide whether the user was previously encountered before one or more networked display devices 100, as shown by decision box 606. If so, the user identifier checks a user profile database to locate the user's profile to determine whether the user is known (i.e., whether a user profile exists for the user), as shown at 616. If so, the user profile is retrieved, as shown at 620, and used by the content selector 216 to select content to present on the display device 100. If a user profile does not exist or the user has not been previously encountered, a user profile for the user may be created, as shown at 608.

User profiles may be generated differently depending on whether the user can be personally or partially identified. As shown at decision box 610, a user who is personally identified by some preset parameters may have a profile created that includes those parameters, as shown at 612. Examples of some of the preset parameters include, without limitation, the user's actual name, social media profile handle or name, phone number, e-mail address, speech, biometrics, identifiers being broadcast or pulled from user client devices, or any other user-specific identifier. Alternatively, if the present naming parameters of the user cannot be ascertained, an anonymous profile for the user may be generated, as shown at 614. Anonymous profiles may include any of the detected physical characteristics of the user, such as, for example but without limitation, height, weight, build, gender, race, age, residence, travel direction, disability, or the like.

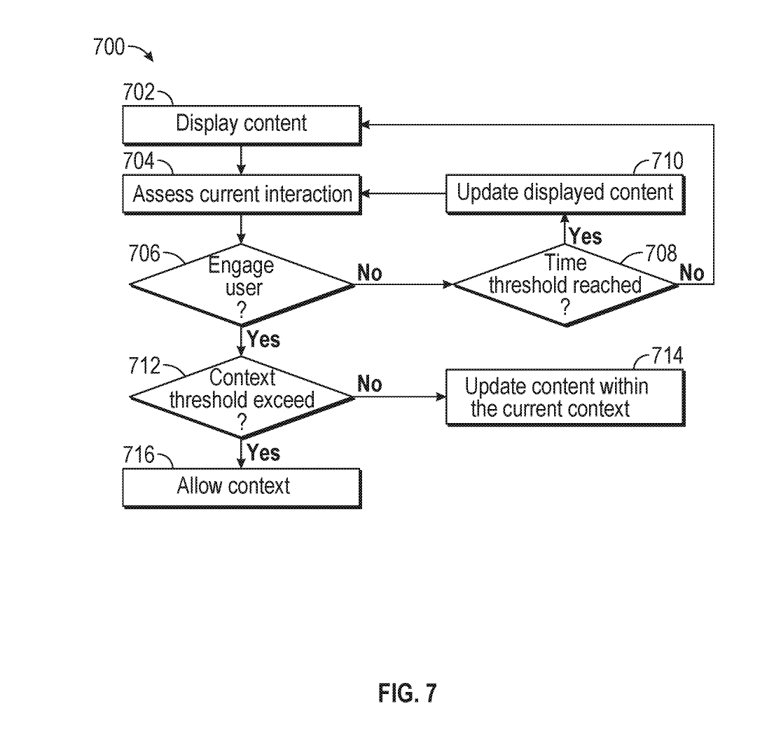

FIG. 7 is a flow chart diagram that illustrates a work flow 700 for the updating displayed content on display devices 100. Initially, content is displayed on a display device 100, as shown at 702. User-interaction conditions are assessed by the display device 100, as shown at 704. Based on the assessed user interactions, the user's level of engagement is assessed, as shown at decision box 706. If the user is not engaged (e.g., the user keeps walking or does not look at the screen), the content is presented for at least a certain time threshold and updated according to the content's play cycles (e.g., a video is allowed to continue playing), as shown at decision box 708 and respective Yes path to 710. The timing operation may be optional, and some examples may instead change the content being presented upon detection of the user's disinterest. But in some examples that employ such a time threshold, if the time expires, new content is displayed, as shown by the No path from decision box 708.

Following the Yes path from decision box 706, if the user is engaged, an engagement context threshold may be monitored to judge the level of user engagement, as shown at box 712. In some examples, interactions may be rated differently based on their underlying action. For example, a user stopping may be given a lesser rating than a QR code scan. The associated ratings of the user's interactions may be assessed collectively or individually to determine whether the engagement context threshold is exceeded. If so, the content may be allowed to play normally, as shown at 716, and if not, the content may be updated to try and entice additional user engagement, as shown at 714.

### Additional Examples

Some examples are directed to identifying users in a public area and presenting targeted content. Such examples may include a presentation device having a viewing area in a public area; a user identification component for recognizing at least one user in the viewing area at a given time; memory storing instructions for identifying content to be presented to the at least one user; and a processor programmed for: identifying physical characteristics of the at least one user in the area, accessing a user profile of the identified at least one user, receiving content selected for presentation to the at least one user during the given time based on at least one user profile characteristic of the identified at least one user, and presenting the received content to the at least one user through the presentation device.

Some examples are directed to controlling the display of content on a public display device based on recognized users in an area. These examples execute operations for: receiving user-specific data comprising one or more physical characteristics of at least one user in a viewing area of the public display device; identifying a location of the public display device and a timeframe when the at least one user is in the area; accessing a user profile of the at least one user; selecting the content for presentation to the at least one user based on the location of the public display, the timeframe when the at least one user is in the area, and the user profile of the at least one user; and directing presentation of the selected content during the timeframe.

Some examples are directed to executable instructions for controlling presentation of content with multiple presentable portions on a computing device, the memories. These instructions are executable for identifying a user in a first public viewing area of a first content display device at an initial time; selecting a first portion of the content to present to the user on the first content display device during the initial time; directing the first portion of the content to be presented to the user on the first content display during the initial time; identifying the user in a second public viewing area of a second content display device at a second time; selecting a second portion of the content to present to the user on the second content display during the second time based on the user having been presented with the first portion of the content; and directing the second portion of the content to be presented to the user on the second content display.

Alternatively or in addition to the other examples described herein, examples include any combination of the following:
a camera for capturing an image of the user while in the area;
for executing a facial recognition module to recognize a face of the at least one user;
recognizing two or more users in the area, and the processor is programmed to select the content for presentation based on the common characteristics of the two or more users in the area;
a second presentation device having a second viewing area in a second public area;
a second user identification component for recognizing the at least one user in the second viewing area at a second time;
a second processor programmed for recognizing the at least one user in the second viewing area, accessing the user profile of the recognized at least one user;
selecting a second piece of content to present to the user based on the user profile and previously presented content to the user on the presentation device during the given time, and presenting the second piece of content to the at least one user through the second presentation device during the second time;
identifying a common characteristic among a plurality of users in the viewing area;
identifying a common characteristic among threshold number of users as a subset of the plurality of users in the viewing area;
updating content on at least one presentation device based upon a threshold number of users nearest to the at least one presentation device;
wherein the one or more physical characteristics comprise at least one of a face, eye, hair color, height, weight, human proportion, gaze, fingerprint, gesture, or facial expression;
the timeframe is calculated based on a determined direction or speed of movement of the user;
the one or more physical characteristics of at least one user are captured by a camera coupled to the public display device;
displaying an indicia in the content that configured to direct a mobile computing device to additional online information related to the content;
the indicia comprises at least one of a QR code, an image, a uniform resource locator, or a tiny uniform resource locator;
receiving user-specific data comprising one or more physical characteristics of a plurality of users in the viewing area of the public display device;
selecting the content for presentation to a group of at least three users based on the location of the public display and a plurality of user profiles that are a subset of the group of users;
performing facial recognition to determine a gaze direction of the user;
identifying the gaze points based on the gaze direction determined through facial recognition;
identifying the user in a third public viewing area of a third content display device at a third time;
selecting a third portion of the content to present to the user on the third content display during the third time based on the user having been presented with the second portion of the content;
directing the third portion of the content to be presented to the user on the third content display; and identifying the user through an anonymous profile.

While the aspects of the disclosure have been described in terms of various examples with their associated operations, a person skilled in the art would appreciate that a combination of operations from any number of different examples is also within scope of the aspects of the disclosure.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Exemplary computer storage media include hard disks, flash drives, and other solid-state memory. Communication media embody data in a signal, such as a carrier wave or other transport mechanism, and include any information delivery media. Computer storage media and communication media are mutually exclusive.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for interactive delivery of public content. For example, the elements illustrated in FIGS. 1 and 2, such as when encoded to perform the operations illustrated in FIGS. 5-7, constitute exemplary means for receiving user-specific data comprising one or more physical characteristics of at least one user in a viewing area of the public display device, identifying a location of the public display device and a timeframe when the at least one user is in the area, accessing a user profile of the at least one user, selecting the content for presentation to the at least one user based on the location of the public display, the timeframe when the at least one user is in the area, and the user profile of the at least one user, and/or directing presentation of the selected content during the timeframe.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, media, and methods without departing from the scope of aspects of the disclosure, it is intended that all matter contained in the above description and shown in the accompanying drawings shall be interpreted as illustrative and not in a limiting sense.

1. An apparatus for identifying users in a public area and presenting targeted content, the apparatus comprising:
a first presentation device having a first viewing area in a first public area;
memory storing instructions for identifying content to be presented to the at least one user; and
one or more processors programmed for:
recognizing one or more physical characteristics of at least one user in a first plurality of users identified within a first viewing area of a first public display device,
receiving, over a network, content to present through the first presentation device, the content being selected based on the recognized one or more physical characteristics of the at least one user and based on other content previously presented to the at least one user recognized in a second group of users at a second presentation device having a separate viewing area than the first presentation device, wherein the first presentation device and the second presentation device areas are located in one or more public areas, and
presenting, to the at least one user through the first presentation device, the received content selected based on the recognized one or more physical characteristics of the at least one user and the other content previously presented to the at least one user at the second presentation device.

2. The device of claim 1, further comprising a camera for capturing an image of the user while in the area.

3. The device of claim 2, wherein the processor is programmed for executing a facial recognition module to recognize a face of the at least one user.

4. The device of claim 1, wherein the processor is configured for recognizing two or more users in the area and selecting the content for presentation based on the common characteristics of the two or more users in the area.

5. The device of claim 1, further comprising:
a third presentation device having a third viewing area in the one or more public areas;
wherein the processor is configured for recognizing the at least one user in the third viewing area at a different time; and
a second processor programmed for:
recognizing the at least one user in the third viewing area at a later time than the received content was previously presented to the user through the first presentation device,
accessing a user profile of the recognized at least one user,
selecting a second piece of content to present to the at least one user based on the user profile and the received content presented to the user on the first presentation device, and
presenting the second piece of content to the at least one user through the third presentation device during the later time.

6. The device of claim 1, wherein the processor is further programmed for identifying a common characteristic among a plurality of users in the viewing area.

7. The device of claim 6, wherein the processor is further programmed for identifying a common characteristic among a threshold number of users as a subset of the plurality of users in the viewing area.

8. The device of claim 6 further comprising a plurality of presentation devices, wherein the processor is further programmed for updating content on at least one of the plurality of presentation devices based upon a threshold number of users recognized nearest to the at least one of the plurality of presentation devices.

9. A method for controlling the display of content on public display devices based on recognized users in an area, the method comprising:
recognizing one or more physical characteristics of at least one user in a first plurality of users identified within a first viewing area of a first public display device;
accessing a user profile of the at least one user;
presenting a first portion of the content to the at least one user based on the user profile and the at least one user being recognized in the first plurality of users within the viewing area of the first public display;
recognizing the at least one user in a second plurality of users in a second viewing area of a second public display, the second viewing area being in a different public area than the first viewing area; and
selecting a second portion of the content to present to the second plurality of users on the second public display based on the first portion of content that was displayed on the first public display to the at least one user and the at least one user being recognized in the second plurality of users in the second viewing area.

10. The method of claim 9, wherein the one or more physical characteristics comprise at least one of a face, eye, hair color, height, weight, human proportion, gaze, fingerprint, gesture, or facial expression.

11. The method of claim 9, wherein the first and second timeframes are calculated based on a determined direction or speed of movement of the user.

12. The method of claim 9, wherein the one or more physical characteristics of at least one user are captured by a camera coupled to the public display device.

13. The method of claim 12, further comprising displaying an indicia in the first or second portion of the content configured to direct a mobile computing device to additional online information related to the content.

14. The method of claim 13, wherein the indicia comprises at least one of a quick response (QR) code, an image, a uniform resource locator, or a tiny uniform resource locator.

15. The method of claim 9, further comprising receiving physical characteristics of a plurality of users in the viewing area of the first or second public display devices.

16. The method of claim 9, further comprising selecting the first or second portions of content for presentation to a group of at least three users based on the location of the first public display.

17. A method for controlling presentation of content with multiple presentable portions on a computing device, the method comprising:
identifying a user in a first building within a first public viewing area of a first content display device at an initial time;
selecting a first portion of the content to present to the user on the first content display device during the initial time;
directing the first portion of the content to be presented to the user on the first content display during the initial time;
identifying the user in a second building within a second public viewing area of a second content display device at a second time;
selecting a second portion of the content to present to the user on the second content display during the second time based on the user having been presented with the first portion of the content and based on the first content displayed during the initial time; and
directing the second portion of the content to be presented to the user on the second content display.

18. The method of claim 17, wherein said monitoring the face of the user through the camera comprises:
performing facial recognition to determine a gaze direction of the user;
identifying the gaze points based on the gaze direction determined through facial recognition.

19. The method of claim 17, further comprising:
identifying the user in a third public viewing area of a third content display device at a third time;
selecting a third portion of the content to present to the user on the third content display during the third time based on the user having been presented with the second portion of the content; and
directing the third portion of the content to be presented to the user on the third content display.

20. The method of claim 17, further comprising identifying the user through an anonymous profile.
